(19) United States
(12) Patent Application Publication
(10) Pub. No.: US 2014/0368596 A1
(43) Pub. Date: Dec. 18, 2014

(54) EXPOSURE APPARATUS AND IMAGE FORMING APPARATUS

(71) Applicant: Canon Kabushiki Kaisha, Tokyo (JP)

(72) Inventor: Daisuke Akagi, Tokyo (JP)

(73) Assignee: Canon Kabushiki Kaisha, Tokyo (JP)

(21) Appl. No.: 14/290,586

(22) Filed: May 29, 2014

(30) Foreign Application Priority Data
Jun. 13, 2013 (JP) 2013-125008

(51) Int. Cl. B41J 2/385

(52) U.S. Cl. CPC G03G 15/043
USPC 347/118

(57) ABSTRACT

An exposure apparatus according to one aspect of this invention includes a plurality of laser light sources (LDs) each configured to output a laser beam of a light power corresponding to a supplied current. The exposure apparatus exposes the surface of a photosensitive drum with a plurality of laser beams. When determining the incident states of the laser beams on the light-receiving surface of a PD, a CPU controls at least one LD as a control target. The CPU causes the control target LD by a current of a predetermined magnitude to emit light and output a laser beam. Based on a light power detection value from the PD for a laser beam output from the control target LD, the CPU determines the incident state of the laser beam on the light-receiving surface of the PD.

### BACKGROUND OF THE INVENTION

1. Field of the Invention

The present invention relates to an exposure apparatus usable in an electrophotographic image forming apparatus, and an image forming apparatus using the exposure apparatus.

2. Description of the Related Art

An edge emitting laser diode can structurally provide front light emitted to the front, and rear light emitted to the rear. There is known a technique in which a photodiode (PD) is mounted in a package, rear light is monitored using the PD, and feedback control is executed to perform automatic power control (to be referred to as APC hereinafter) of controlling a light power of the front light.

A surface emitting laser diode (VCSEL: Vertical Cavity Surface Emitting Laser) cannot structurally provide rear light. Thus, there is known a technique of performing APC by reflecting part of front light by a beam splitter such as a half mirror, monitoring the light by a PD arranged outside to perform feedback control, as disclosed in Japanese Patent Laid-Open No. 2005-156933. Further, there is also known a technique of performing APC by performing feedback control using an output from a synchronization detection sensor (BD sensor) which detects the write position timing, as disclosed in Japanese Patent Laid-Open No. 2006-91553.

However, in the above-mentioned APC using front light, the position at which the PD, BD sensor, optical component, or the like is arranged may shift owing to vibrations, or a member may be deformed owing to an abrupt temperature change. As a result, the position of the incident point of a laser beam on the light-receiving surface of the PD or BD sensor may shift. In this case, the laser beam may not normally enter the light-receiving surface of the PD, and APC may not be executed normally. Also, the laser light source (laser diode) itself may fail, or the image formation quality may degrade.

The possibility that these problems will occur can be decreased by increasing, for example, the area of the light-receiving surface of the PD sensor. However, as the area of the light-receiving surface of the PD sensor becomes larger, the internal capacitance between terminals generally becomes larger and the response characteristic becomes poorer. Increasing the area of the light-receiving surface of the PD sensor may prolong the time taken for APC.

### SUMMARY OF THE INVENTION

The present invention has been made to solve the above-described problems. The present invention provides a technique of appropriately determining the incident state of a laser beam on the light-receiving surface of a light power detection element (PD) configured to detect the light powers of laser beams output from a plurality of laser light sources in an exposure apparatus.

According to one aspect of the present invention, there is provided an exposure apparatus which exposes a surface of a photosensitive member with a plurality of laser beams, comprising: a plurality of laser light sources each configured to output a laser beam of a light power corresponding to a supplied current; a beam splitter configured to split each of the plurality of laser beams emitted by the plurality of laser light sources; an optical member configured to guide one laser beam split by the beam splitter to the photosensitive member for each of the plurality of laser beams; a light-receiving unit configured to receive another laser beam split by the beam splitter for each of the plurality of laser beams; a light power detection unit configured to detect a light power of the laser beam entering the light-receiving unit; an light emission control unit configured to control, as a control target, at least one laser light source among the plurality of laser light sources, the emission control unit supplying a current of a predetermined value to cause the laser light source serving as the control target to emit light and output a laser beam; and a determination unit configured to determine an incident state of the laser beam on the light-receiving unit, based on a result of comparison between the predetermined current value and a light power detection value from the light power detection unit for the laser beam output from the laser light source serving as the control target by the emission control unit.

According to another aspect of the present invention, there is provided an image forming apparatus including a photosensitive member, comprising: a charging unit configured to charge a surface of the photosensitive member; an exposure apparatus configured to expose the surface of the photosensitive member with a plurality of laser beams output from a plurality of laser light sources; and a developing unit configured to develop an electrostatic latent image formed on the surface of the photosensitive member by exposure by the exposure apparatus, and form, on the surface of the photosensitive member, an image to be transferred to a printing medium, wherein the exposure apparatus includes: the plurality of laser light sources each configured to output a laser beam of a light power corresponding to a supplied current; a beam splitter configured to split each of the plurality of laser beams emitted by the plurality of laser light sources; an optical member configured to guide one laser beam split by the beam splitter to the photosensitive member for each of the plurality of laser beams; a light-receiving unit configured to receive another laser beam split by the beam splitter for each of the plurality of laser beams; a light power detection unit configured to detect a light power of the laser beam entering the light-receiving unit; an emission control unit configured to control, as a control target, at least one laser light source among the plurality of laser light sources, the emission control unit supplying a current of a predetermined value to cause the laser light source serving as the control target to emit light and output a laser beam; and a determination unit configured to determine an incident state of the laser beam on the light-receiving unit, based on a result of comparison between the predetermined current value and a light power detection value from the light power detection unit for the laser beam output from the laser light source serving as the control target by the emission control unit.

According to the present invention, the incident state of a laser beam on the light-receiving surface of a PD configured to detect the light powers of laser beams output from a plurality of laser light sources in an exposure apparatus can be determined appropriately.

Further features of the present invention will become apparent from the following description of exemplary embodiments (with reference to the attached drawings).

### BRIEF DESCRIPTION OF THE DRAWINGS

FIG. 1 is a schematic sectional view showing the arrangement of an image forming apparatus 100 according to the first embodiment;

FIG. 2 is a view showing the arrangement of a laser scanner 101 according to the first embodiment;

FIG. 3 is a block diagram showing the arrangements of a laser control unit 210 and controller 250 according to the first embodiment;

FIG. 4 is a view showing an example of incident points when laser beams output from respective laser diodes (LDs) enter a light-receiving surface 400 of a photodiode (PD) 213 according to the first embodiment;

FIG. 5 is a table showing a list of control modes of the laser control unit 210 that correspond to control signals from the controller 250 according to the first embodiment;

FIGS. 6A, 6B, and 6C are views showing examples of the incident states of laser beams from the respective LDs on the light-receiving surface 400 of the PD 213 in inspection processing of an LD 200 according to the first embodiment;

FIG. 7 is a flowchart showing the procedures of inspection processing of the LD 200 to be executed by a CPU 301 according to the first embodiment;

FIG. 8 is a view showing an example of image data conversion processing in an apparatus life extending mode according to the first embodiment;

FIG. 9 is a view showing an example of image data conversion processing in the apparatus life extending mode according to the first embodiment; and

FIG. 10 is a view showing an example of incident points when laser beams output from respective LDs enter a light-receiving surface 400 of a PD 213 according to the second embodiment.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

<Image Forming Apparatus>

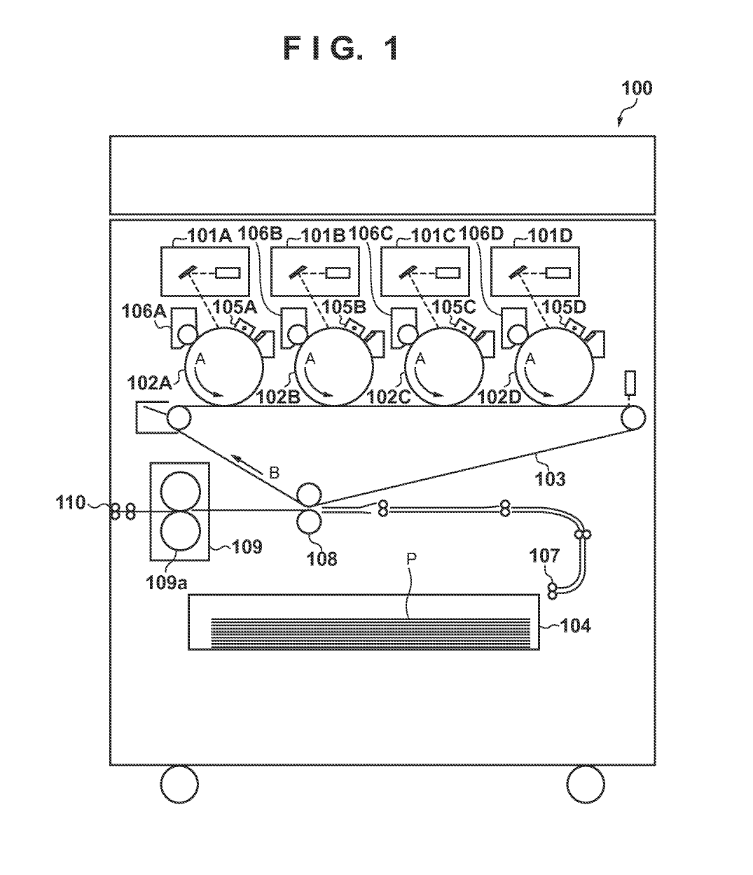

First, the arrangement and operation of an image forming apparatus 100 according to the first embodiment of the present invention will be described with reference to FIG. 1. In the first embodiment, the image forming apparatus 100 is an electrophotographic multi-color copying apparatus in which an exposure apparatus (laser scanner) is mounted. In the embodiment, laser scanners 101, that is, 101A to 101D shown in FIG. 1 are an example of exposure apparatuses (optical scanning apparatuses) which expose the surfaces of photosensitive members by a plurality of laser beams. In the following description, a notation without suffixes A to D, like the laser scanner 101, indicates each of components with suffixes A to D (for example, each of the laser scanners 101A to 101D).

The image forming apparatus 100 includes a plurality of photosensitive drums 102A to 102D (photosensitive members) bearing toner images of different colors formed on the surfaces. The photosensitive drums 102 (102A to 102D) rotate in directions indicated by arrows A in FIG. 1. When forming toner images on the surfaces of the photosensitive drums 102 (102A to 102D), primary chargers 105 (105A to 105D) first uniformly charge the surfaces of the corresponding photosensitive drums 102. Then, the exposure apparatuses (laser scanners) 101 (101A to 101D) output laser beams modulated based on image data corresponding to the respective colors, and irradiate the photosensitive drums 102 with the output laser beams. In this manner, each laser scanner 101 exposes the surface of the corresponding photosensitive drum 102 with a laser beam, thereby forming an electrostatic latent image on the surface of the photosensitive drum 102. Note that the laser beam scanning direction on the surface of the photosensitive drum 102 is defined as a “main scanning direction”, and a direction perpendicular to the main scanning direction is defined as a “sub-scanning direction”.

Then, the electrostatic latent images formed on the surfaces of the photosensitive drums 102 are developed with toners of the respective colors stored in developing units 106 (106A to 106D), thereby forming the toner images of the respective colors on the surfaces of the photosensitive drums. Along with the rotation of the photosensitive drums 102, the toner images of the respective colors formed on the surfaces of the photosensitive drums 102 are conveyed to primary transfer nip portions between the photosensitive drums 102 and an intermediate transfer belt 103. The intermediate transfer belt 103 rotates in a direction indicated by an arrow B in FIG. 1 (the peripheral surface of the belt moves). At the primary transfer nip portions corresponding to the respective photosensitive drums 102A to 102D, the toner images of the respective colors are superimposed and transferred from the surfaces of the photosensitive drums 102A to 102D to the surface of the intermediate transfer belt 103 (primary transfer). As a result, a multi-color toner image (image) is formed on the surface of the intermediate transfer belt 103.

Along with the movement of the intermediate transfer belt 103, the image formed on the surface of the intermediate transfer belt 103 is conveyed to a secondary transfer nip portion between a secondary transfer roller 108 and the intermediate transfer belt 103. In synchronism with the conveyance timing of the image on the intermediate transfer belt 103, recording media (sheets) P in a paper feed unit 104 are fed one by one onto the conveyance path by pickup rollers 107 and conveyed to the secondary transfer nip portion. At the secondary transfer nip portion, the image formed on the intermediate transfer belt 103 is transferred to the surface of the sheet P by the secondary transfer roller 108 (secondary transfer).

The sheet P bearing the image transferred on the surface is conveyed to a fixing unit 109. The fixing unit 109 includes a fixing roller 109a which incorporates a heat source such as a halogen heater. The fixing unit 109 fixes the image onto the surface of the sheet P by applying heat and pressure by the fixing roller 109a to the sheet P conveyed into the fixing unit 109. Finally, the sheet P bearing the image formed on the surface is discharged from the image forming apparatus 100 via a discharge unit 110.

<Laser Scanner>

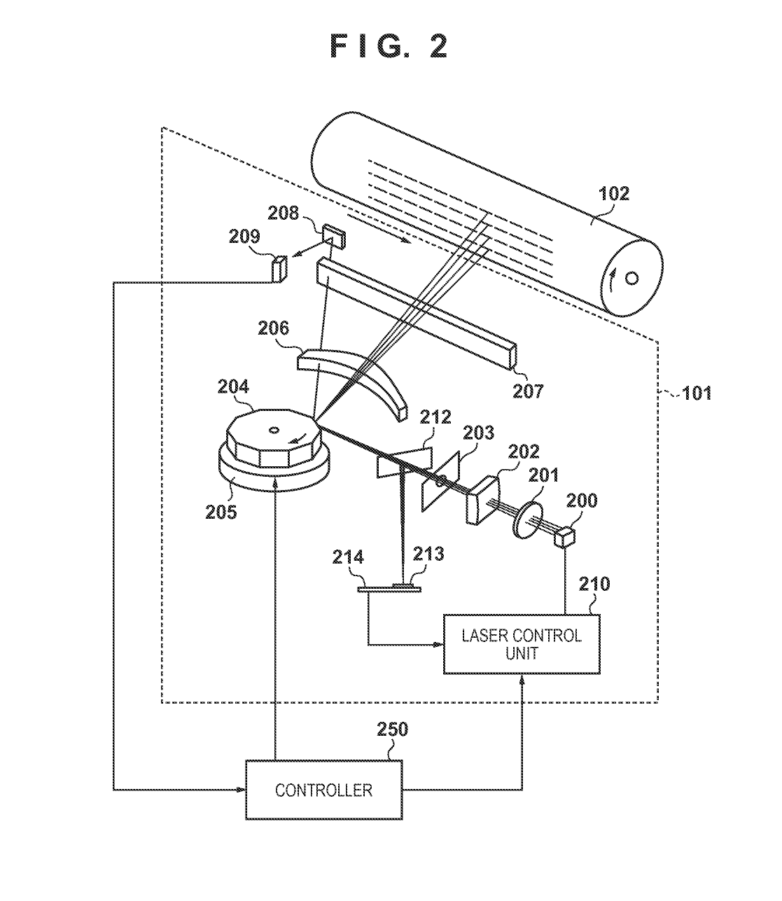

The arrangement and operation of the laser scanner 101 will be described with reference to FIG. 2. The laser scanner 101 includes a laser diode (LD) 200, a collimator lens 201, a cylindrical lens 202, an aperture stop 203, a half mirror 212 (beam splitter), a photodiode (PD) (PD sensor) 213, a PD substrate 214, a polygon mirror 204, a polygon motor 205, fθ lenses 206 and 207, a reflecting mirror 208, a BD (Beam Detector) sensor 209 for synchronization, and a laser controller 210.

The LD 200 is a multi-beam LD which includes n (n is an integer of 2 or more) LDs and can output n laser beams from the n LDs. In the embodiment, the n LDs will be referred to as LD1, LD2, . . . , LDn (LD1 to LDn). LD1 to LDn are equivalent to a plurality of laser light sources, and output laser beams in light powers corresponding to supplied currents (driving currents).

The laser control unit 210 performs light emission control of the respective LDs (LD1 to LDn) included in the LD 200 in accordance with a control signal from a controller 250. Each laser beam output from the LD 200 is collimated into a parallel ray via the collimator lens 201, and enters the cylindrical lens 202. The cylindrical lens 202 has a refractive index in only the sub-scanning direction, and converges the incident parallel ray in the sub-scanning direction. The laser beam having passed through the cylindrical lens 202 is narrowed down to a predetermined diameter in the main scanning direction by the aperture stop 203, and then enters the half mirror 212. Part of the laser beam entering the half mirror 212 is reflected toward the PD 213, and the remaining part of the laser beam passes through the half mirror 212 and enters the polygon mirror 204.

When the laser beam reflected by the half mirror 212 enters the PD 213, the PD 213 outputs, to the PD substrate 214, a current corresponding to the light power of incident laser beam. The PD substrate 214 converts the current input from the PD 213 into a voltage, and transmits the converted voltage to the laser control unit 210. Based on the voltage transmitted from the PD substrate 214, the laser control unit 210 controls the light power of the LD 200, which will be described later.

The polygon mirror 204 has a plurality of reflecting surfaces, and rotates in accordance with a control signal from the controller 250. When the laser beam having passed through the half mirror 212 enters one of the reflecting surfaces of the polygon mirror 204, it is reflected by the reflecting surface at successive angles along with the rotation of the polygon mirror 204, thereby scanning the laser beam. The laser beam scanned by the polygon mirror 204 passes through the fθ lenses 206 and 207, and the surface of the photosensitive drum 102 is irradiated with the laser beam to scan the surface of the photosensitive drum 102. The fθ lens 206 is used to scan the laser beam at a predetermined speed on the surface of the photosensitive drum 102, and to converge the beam spot in the main scanning direction.

The laser beam scanned by the polygon mirror 204 is reflected by the reflecting mirror 208 at a predetermined timing, and enters the BD sensor 209 for synchronization. Upon receiving the laser beam, the BD sensor 209 outputs, to the controller 250, a BD signal representing that the laser beam has been detected. The BD signal output from the BD sensor 209 is a signal used to synchronize the rotation of the polygon mirror 204 and the image write start timing. The controller 250 monitors the BD signal from the BD sensor 209, and controls the polygon motor 205 which drives the polygon mirror 204 so that the rotation period of the polygon mirror 204 always becomes constant based on a laser beam detection timing represented by the BD signal.

<Laser Control Unit>

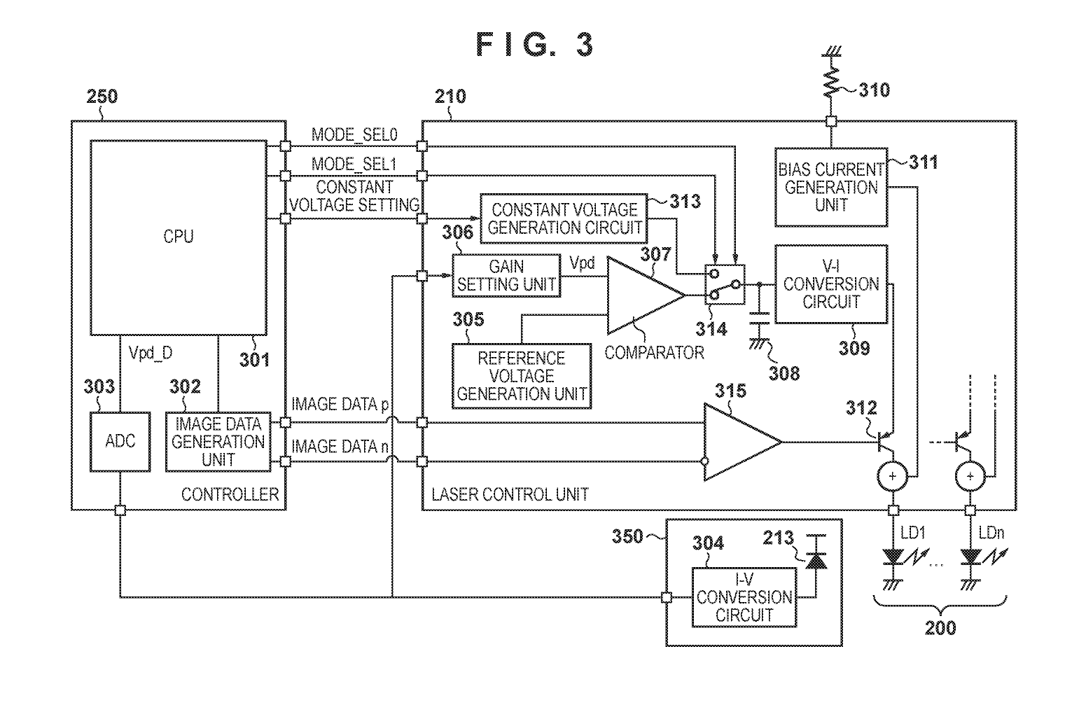

Next, the arrangement and operation of the laser control unit 210 will be described with reference to FIG. 3. FIG. 3 is a block diagram showing the arrangements of the laser control unit 210 and controller 250. As shown in FIG. 3, the controller 250, the LD 200, and a PD unit 350 are connected to the laser control unit 210. The laser control unit 210 controls the LD 200 based on a control signal and image data input from the controller 250, and a voltage (light power monitoring voltage) Vpd input from the PD unit 350. The embodiment assumes that the number n of LDs included in the LD 200 is 32. The LD 200 includes 32 LDs (LD1 to LD32) arranged side by side in line (linearly), and can simultaneously output 32 laser beams from LD1 to LD32.

The controller 250 transmits a control signal and image data to the laser control unit 210. The controller 250 includes a CPU 301, image data generation unit 302, and analog/digital converter (ADC) 303. The ADC 303 converts an analog voltage Vpd input from the PD unit 350 into a digital value Vpd_D, and outputs the digital voltage Vpd_D to the CPU 301. The CPU 301 controls the laser control unit 210 by control signals (MODE_SEL0, MODE_SEL1, and constant voltage setting value) to be transmitted to the laser control unit 210. The image data generation unit 302 generates image data, and outputs the generated image data to the laser control unit 210.

The PD unit 350 includes the PD substrate 214 (not shown), the PD 213 arranged on the PD substrate 214, and a current-to-voltage conversion circuit (I-V conversion circuit) 304 formed in the PD substrate 214. When a laser beam is output from the LD 200, reflected by the half mirror 212, and enters the PD 213, the PD 213 outputs, to the I-V conversion circuit 304, a current corresponding to the light power (incident light power) of the incident laser beam. The I-V conversion circuit 304 converts the current input from the PD 213 into a voltage, and transmits the converted voltage Vpd to the laser control unit 210 and controller 250.

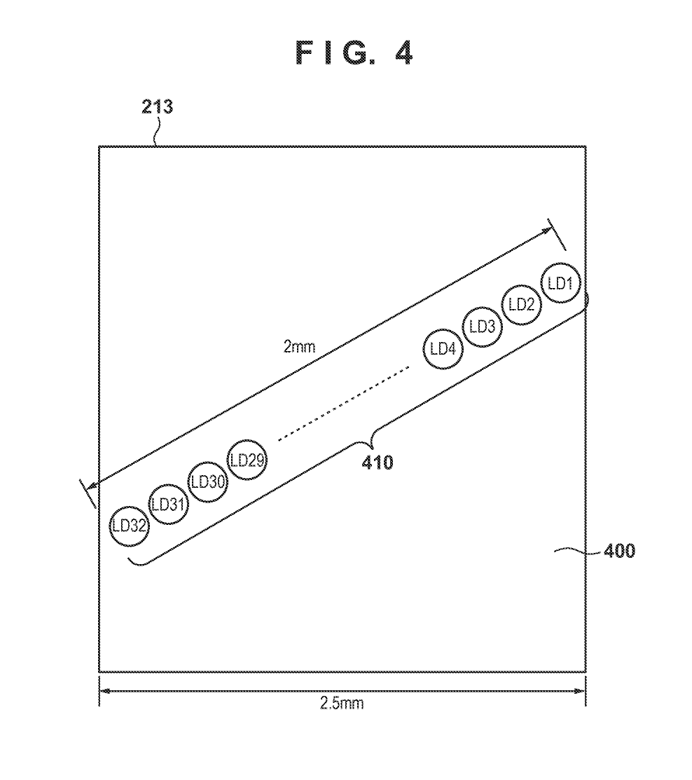

Thirty-two laser beams which have been output from LD1 to LD32 of the LD 200 and reflected by the half mirror 212 enter the light-receiving surface of the PD 213. The PD 213 has a light-receiving surface 400 of, for example, a square shape having one side of about 2.5 mm, as shown in FIG. 4. In factory shipment of the image forming apparatus 100, the laser scanner 101 is adjusted so that all laser beams output from LD1 to LD32 enter the light-receiving surface 400 of the PD 213. In the embodiment, since LD1 to LD32 are arranged in line, the 32 laser beams enter a plurality of incident points 410 arranged in line (linearly) on the light-receiving surface 400 of the PD 213, as shown in FIG. 4. The width of the laser beam incident on the light-receiving surface 400 is, for example, about 2 mm. In the embodiment, the PD 213 (or PD unit 350) is an example of a light power detection unit which has the light-receiving surface 400 for receiving a plurality of laser beams output from a plurality of LDs (LD1 to LD32) and detects the power of light incident on the light-receiving surface.

As shown in FIG. 3, the laser control unit 210 includes at least a reference voltage generation unit 305, gain setting unit 306, comparator 307, sample and hold capacitor (S/H capacitor) 308, voltage-to-current conversion circuit (V-I conversion circuit) 309, bias current generation unit 311, driving switch (transistor) 312, constant voltage generation circuit 313, switch 314, and logic element 315. The reference voltage generation unit 305 generates a reference voltage Vref to be used as the target value of automatic power control (APC) to be described later, and inputs it to the comparator 307. The gain setting unit 306 amplifies the light power monitoring voltage Vpd transmitted from the PD unit 350 to adjust the gain of this voltage.

After the light power monitoring voltage Vpd is amplified by the gain setting unit 306, it is input to the comparator 307. The comparator 307 compares the reference voltage Vref with the light power monitoring voltage Vpd amplified by the gain setting unit 306, and outputs the comparison result. The S/H capacitor 308 is charged or discharged in accordance with an output from the comparator 307, which changes the terminal voltage. The V-I conversion circuit 309 converts the terminal voltage of the S/H capacitor 308 into a current, and outputs the converted current as a switching current to the driving switch 312.

The bias current generation unit 311 supplies, to the LD 200 (LD1 to LDn), a bias current determined by the resistance value of a resistor 310 externally connected to the laser control unit 210. Also, the switching current output from the V-I conversion circuit 309 is supplied to the LD 200 (LD1 to LDn) via the driving switch 312. The driving switch 312 switches the supply state of the switching current to the LD 200 between the ON state and the OFF state in accordance with image data input from the image data generation unit 302 (via the logic element 315). Accordingly, the driving switch 312 performs switching driving of the LD 200 in accordance with input image data.

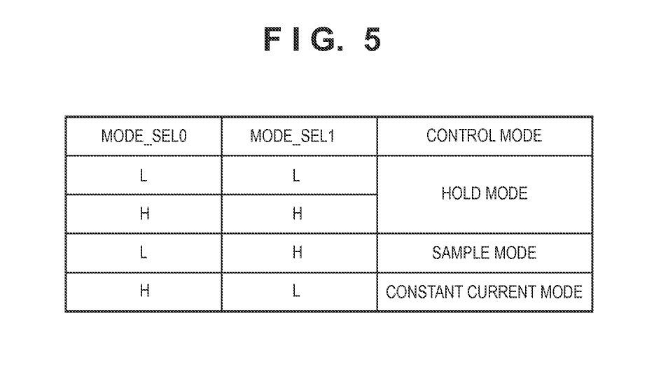

The constant voltage generation circuit 313 outputs, to the switch 314, a voltage of a constant value set as a constant voltage setting value from the controller 250. The voltage output from the constant voltage generation circuit 313, and the voltage output from the comparator 307 are input to the switch 314. The switch 314 selectively outputs either of the input voltages in accordance with control signals (digital signals MODE_SEL0 and MODE_SEL1) input from the CPU 301. In response to this, the control mode of the laser control unit 210 is switched to one of the sample mode, hold mode, and constant current mode (to be described later with reference to FIG. 5).

<Operation of Switch>

The control mode of the laser control unit 210 will be described with reference to FIG. 5. The control mode of the laser control unit 210 can be switched by the switch 314. The controller 250 (CPU 301) transmits the digital signals MODE_SEL0 and MODE_SEL1 of 2 bits to the switch 314 as control signals to the laser control unit 210. The control mode of the laser control unit 210 is switched in accordance with the digital signals of 2 bits, as shown in FIG. 5.

As shown in FIG. 5, when both MODE_SEL0 and MODE_SEL1 are “L” or “H”, the laser control unit 210 changes to the “hold mode”, in which the S/H capacitor 308 holds accumulated charges. This is implemented when the switch 314 switches to a state in which the S/H capacitor 308 is open. The “hold mode” is used to actually expose the photosensitive drum 102 based on image data.

When MODE_SEL0=“L” and MODE_SEL1=“H”, the laser control unit 210 changes to the “sample mode”, in which the S/H capacitor 308 is charged or discharged in accordance with the light power monitoring voltage Vpd from the PD 213. This is implemented when the switch 314 switches to a state in which the comparator 307 and S/H capacitor 308 are connected. The “sample mode” is used to perform APC to be described later.

When MODE_SEL0=“H” and MODE_SEL1=“L”, the laser control unit 210 changes to the “constant current mode”, in which a constant current is supplied to the LD 200 by applying, to the S/H capacitor 308, a constant voltage output from the constant voltage generation circuit 313. This is implemented when the switch 314 switches to a state in which the constant voltage generation circuit 313 and S/H capacitor 308 are connected.

<Constant Current Control>

Constant current control to be executed in the constant current mode among the above-described control modes will be explained. As will be described later, the constant current control is used in inspection processing of the LD 200. The constant current control is control of causing, by a predetermined current set in advance, the LD 200 to emit light. When performing the constant current control, the CPU 301 sets the control mode of the laser control unit 210 to the constant current mode by using the control signals. For the constant current control, the CPU 301 sets a predetermined voltage value (digital value) in advance in the constant voltage generation circuit 313 when the image forming apparatus 100 is turned on.

In the constant current mode, the constant voltage generation circuit 313 outputs a voltage corresponding to the set digital value. The constant voltage output from the constant voltage generation circuit 313 is applied to the S/H capacitor 308 via the switch 314. Then, the S/H capacitor 308 is charged, and its terminal voltage becomes the constant voltage. As a result, constant current control is implemented in the constant current mode, in which the LD 200 is driven by a constant current and outputs a laser beam of a constant light power modulated in accordance with image data.

<Automatic Power Control (APC)>

Next, APC of the LD 200 by the laser control unit 210 will be explained. APC corresponds to an operation of controlling, to a predetermined target light power, the light power of a laser beam output from the LD 200 (LD1 to LD32). When performing APC by the laser control unit 210, the controller 250 sets in advance the laser control unit 210 in the sample mode. Note that the laser control unit 210 (light power control unit) selectively executes the following APC for each of LD1 to LD32 included in the LD 200. More specifically, the laser control unit 210 performs APC individually (in order) for each of LD1 to LD32 under the control of the controller 250.

When the PD 213 receives a laser beam output from the LD 200 upon emission, the PD 213 outputs a current corresponding to the light power of the laser beam to the I-V conversion circuit 304. The I-V conversion circuit 304 converts the input current into a voltage, and transmits a signal representing the voltage to the laser control unit 210. When the laser control unit 210 receives the voltage corresponding to the light power of the laser beam received by the PD 213, the gain setting unit 306 amplifies the voltage by a predetermined gain, and outputs the amplified voltage as the light power monitoring voltage Vpd to the comparator 307. The comparator 307 compares the input light power monitoring voltage Vpd with the reference voltage Vref input from the reference voltage generation unit 305. Note that the gain setting value of the gain setting unit 306 is set based on measurement in factory shipment so that the light power of the LD 200 becomes a predetermined target light power. The preset gain setting value is set in the gain setting unit 306 when the image forming apparatus 100 is turned on.

If the result of comparison between the light power monitoring voltage Vpd and the reference voltage Vref is

Vpd<Vref (1)

the comparator 307 determines that the light power of the LD 200 is lower than the target light power corresponding to the reference voltage Vref, and increases the light power of the LD 200. More specifically, the comparator 307 supplies a current to the S/H capacitor 308 to charge the S/H capacitor 308, thereby raising the terminal voltage. As a result, a current to be supplied from the V-I conversion circuit 309 to the LD 200 increases, and the light power of the LD 200 increases.

In contrast, if

Vpd>Vref (2)

the comparator 307 determines that the light power of the LD 200 is higher than the target light power corresponding to the reference voltage Vref, and decreases the light power of the LD 200. More specifically, the comparator 307 draws a current from the S/H capacitor 308 to discharge the S/H capacitor 308, thereby lowering the terminal voltage. As a result, a current to be supplied from the V-I conversion circuit 309 to the LD 200 decreases, and the light power of the LD 200 decreases.

In the sample mode, the laser control unit 210 adjusts the terminal voltage of the S/H capacitor 308 by the above-described APC, and controls the light power of a laser beam output from the LD 200 (LD1 to LD32) to a predetermined light power (target light power). For each of LD1 to LD32, the laser control unit 210 performs this APC by controlling a current to be supplied to the LD so that the light power monitoring voltage Vpd serving as a light power detection value from the PD 213 becomes equal to the reference voltage Vref serving as a target value corresponding to the target light power. According to the above-described APC, the light power of a laser beam output from the LD 200 can be controlled to be a target light power even when the characteristic of the LD 200 changes upon a temperature change or degradation of durability.

However, if the position of the PD 213 shifts or a plastic optical component or the like is thermally deformed to change the characteristic of the PD 213 owing to vibrations, abrupt temperature fluctuations, or the like, a laser beam may not normally enter the light-receiving surface 400 of the PD 213. In such a case, it may become difficult to detect a laser beam output from the LD 200 (LD1 to LD32) by the PD 213.

More specifically, the light power monitoring voltage Vpd from the PD 213 becomes very small, and the comparator 307 results in always determining that

Vpd<<Vref (3)

That is, the comparator 307 results in determining that the light power of the LD 200 is insufficient, and keeping increasing the terminal voltage of the S/H capacitor 308 in order to increase the light power. As a result, a current supplied to the LD 200 also keeps increasing and becomes an overcurrent, and the LD 200 may fail. Even if a current large enough to cause a failure is not supplied, the LD 200 outputs a laser beam of a very high light power, and the image formation quality may degrade. It is therefore necessary to determine, for each of a plurality of LDs (LD1 to LD32), whether or not an output laser beam has normally entered the light-receiving surface 400 of the PD 213 (that is, to determine the incident state of a laser beam on the light-receiving surface 400). The aforementioned failure of the LD is enabled to be prevented before it happens, by specifying an LD in a state (abnormal state) in which the incident state of a laser beam on the light-receiving surface 400 is abnormal, and then, for example, allowing an operator to take an appropriate measure.

In the embodiment, the laser scanner 101 performs inspection processing of the LD 200 to determine whether or not a laser beam output from the LD 200 has normally entered the light-receiving surface 400 of the PD 213. More specifically, in inspection processing, the CPU 301 controls, as a control target, at least one of the plurality of LDs (LD1 to LD32) included in the LD 200, and causes the control target LD to output a laser beam by causing the control target LD to emit light. At the time of inspection processing, the CPU 301 causes the control target LD to output a laser beam by causing the control target LD to emit light based on a current of a predetermined magnitude. Further, the CPU 301 determines, based on a light power detection value from the PD 213 for a laser beam output from the control target LD, the incident state of the laser beam on the light-receiving surface 400 of the PD 213. More specifically, the CPU 301 compares the detection value with a predetermined reference value Vset, corresponding to the predetermined magnitude, to determine the incident state of a laser beam on the light-receiving surface 400 of the PD 213. By this determination processing based on the light power detection value from the PD 213, the incident state of a laser beam corresponding to each LD on the light-receiving surface 400 can be determined easily and appropriately.

<LD Inspection Processing>

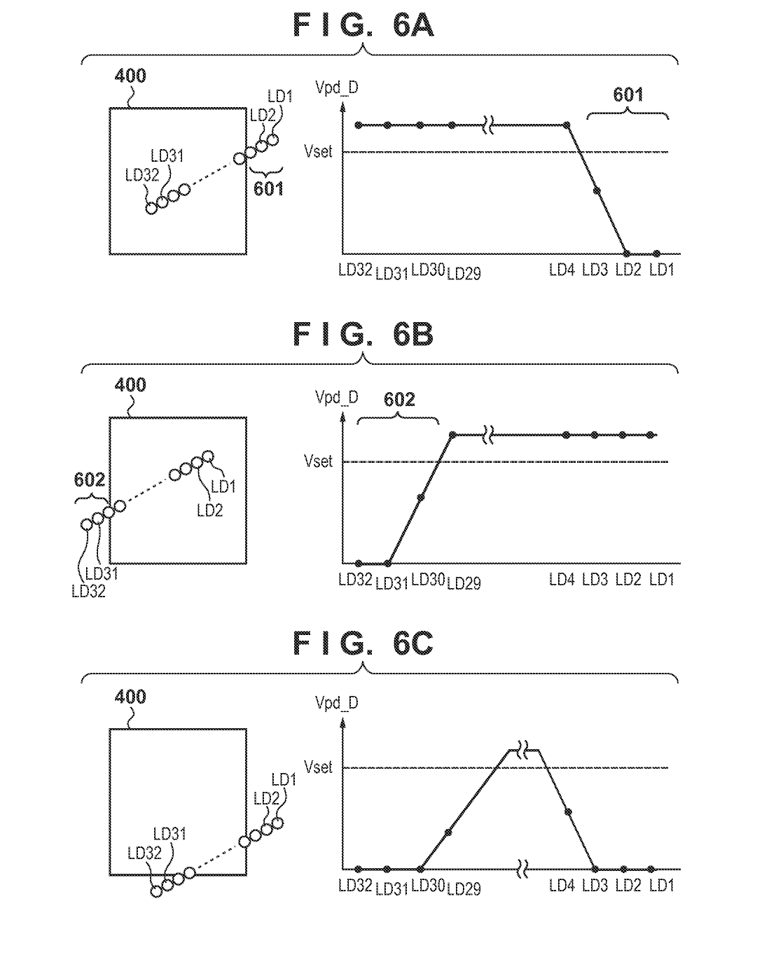

As a feature of the embodiment, particularly, the LD 200 is configured by arranging the plurality of LDs (LD1 to LD32) on line, as described above. In this case, by appropriately selecting LDs to be caused to emit light for the above-described inspection processing, the inspection processing can be completed in a shorter time without emitting light from all the LDs. As will be described with reference to FIGS. 6A, 6B, and 6C, one feature of the embodiment is to, if possible, limit the number of control target LDs in inspection processing of the LD 200, for which the incident state of a laser beam on the light-receiving surface 400 is determined. Inspection processing can therefore be completed in a shorter time. However, the present embodiment is not limited to the case in which a plurality of LDs are arranged linearly, and is applicable to an arbitrary arrangement.

Inspection processing of the LD 200 in the embodiment will be explained with reference to FIGS. 6A, 6B, and 6C. In inspection processing of the LD 200, the incident state of a laser beam on the light-receiving surface 400 of the PD 213 is basically determined as follows for each of LD1 to LD32. In inspection processing of the LD 200, the laser control unit 210 uses the above-mentioned constant current mode. In the constant current mode, a constant current of a predetermined magnitude is supplied to a control target LD to cause the LD to emit light and output a laser beam. By the laser beam entering the PD 213 via the half mirror 212, the PD unit 350 outputs the voltage (light power monitoring voltage) Vpd corresponding to the light power of the laser beam, as the detection result (detection value) of the light power of the laser beam. The voltage Vpd is transmitted to the ADC 303 in the controller 250. The ADC 303 converts the voltage Vpd from an analog value into a digital value Vpd_D, and outputs the digital value Vpd_D to the CPU 301.

If the light power monitoring voltage Vpd_D exceeds the reference value Vset (Vpd_D>Vset), the CPU 301 determines that the incident state of the laser beam is the normal state in which the laser beam has entered the light-receiving surface 400. In contrast, if the light power monitoring voltage Vpd_D does not exceed the reference value Vset (Vpd_D Vset), the CPU 301 determines that the incident state of the laser beam is the abnormal state in which the laser beam has not entered the light-receiving surface 400. Note that the reference value Vset is also set in advance as a digital value, similar to the light power monitoring voltage Vpd_D. A current of a predetermined magnitude to be used in the constant current mode is set by preliminary measurement. This current is set to have a magnitude small enough not to cause a failure of each LD and not to become equal to or smaller than the reference value Vset when a laser beam output from the LD enters the light-receiving surface 400.

FIGS. 6A, 6B, and 6C are views showing examples of the incident states of laser beams output from LD1 to LD32 arranged linearly in line on the light-receiving surface 400 of the PD 213 in inspection processing of the LD 200. In FIGS. 6A, 6B, and 6C, a plurality of laser beams enter a plurality of incident points arranged linearly in correspondence with the arrangement of LD1 to LD32. FIGS. 6A, 6B, and 6C show examples of incident points when laser beams output from LD1 to LD32 enter the light-receiving surface 400. FIGS. 6A, 6B, and 6C show states in which some incident points deviate from the light-receiving surface 400 in different patterns.

As shown in FIGS. 6A, 6B, and 6C, in a case where LD1 to LD32 are arranged linearly, the incident points of laser beams corresponding to adjacent LDs deviate from the light-receiving surface 400 in order from a laser beam corresponding to an LD (LD1 or LD32) arranged at either end. For this reason, the CPU 301 may select adjacent LDs as control targets in order from LD1 or LD32 arranged at the end, out of LD1 to LD32. In the selection order, the CPU 301 may determine, based on the light power monitoring voltage Vpd_D, the incident state of a laser beam output from each LD on the light-receiving surface 400.

FIG. 6A shows a case in which corresponding incident points on the LD1 side deviate from the light-receiving surface 400. FIG. 6B shows a case in which corresponding incident points on the LD32 side deviate from the light-receiving surface 400. As shown in FIGS. 6A and 6B, incident points corresponding to LD1 and LD3 within a range 601, and incident points corresponding to LD30 and LD32 within a range 602 deviate from the light-receiving surface 400, and the corresponding laser beams do not enter the light-receiving surface 400. In FIGS. 6A and 6B, therefore, light power monitoring voltages Vpd_D corresponding to LD1 to LD3 within the range 601, and LD30 to LD32 within the range 602 become lower than the reference value Vset.

By using the characteristics shown in FIGS. 6A and 6B, the CPU 301 can reduce in the following way the number of LDs caused to emit light as control targets for inspection processing. In a case where LD1 to LD32 are arranged linearly, the CPU 301 selects LD1 and LD32 arranged at two ends as control targets for inspection processing, and causes them to emit light. The CPU 301 selects adjacent LDs as control targets in order from LD1 or LD32 for which it is determined that the incident state on the light-receiving surface 400 is the abnormal state. Then, the CPU 301 causes the selected LDs to emit light. If the CPU 301 determines, while causing the LDs to emit light in order, that the incident state of a laser beam output from one of the LDs on the light-receiving surface 400 is the normal state, the CPU 301 may end the LD control. In this case, the remaining LDs not selected as control targets are always in the normal state, as shown in FIGS. 6A and 6B. Thus, the CPU 301 may automatically determine that the remaining LDs not selected as control targets are in the normal state. Accordingly, inspection processing of the LD 200 can be completed without emitting light from some LDs, and the inspection processing can be completed in a shorter time.

As shown in FIG. 6C, in a case where LD1 and LD32 arranged at two ends are first caused to emit light and the incident states of two corresponding laser beams on the light-receiving surface 400 are the abnormal state, the incident points of many laser beams are highly likely to deviate from the light-receiving surface 400. In such a case, the CPU 301 may execute LD inspection processing by selecting all LD1 to LD32 in order as control targets and causing them to emit light.

<Procedures of LD Inspection Processing>

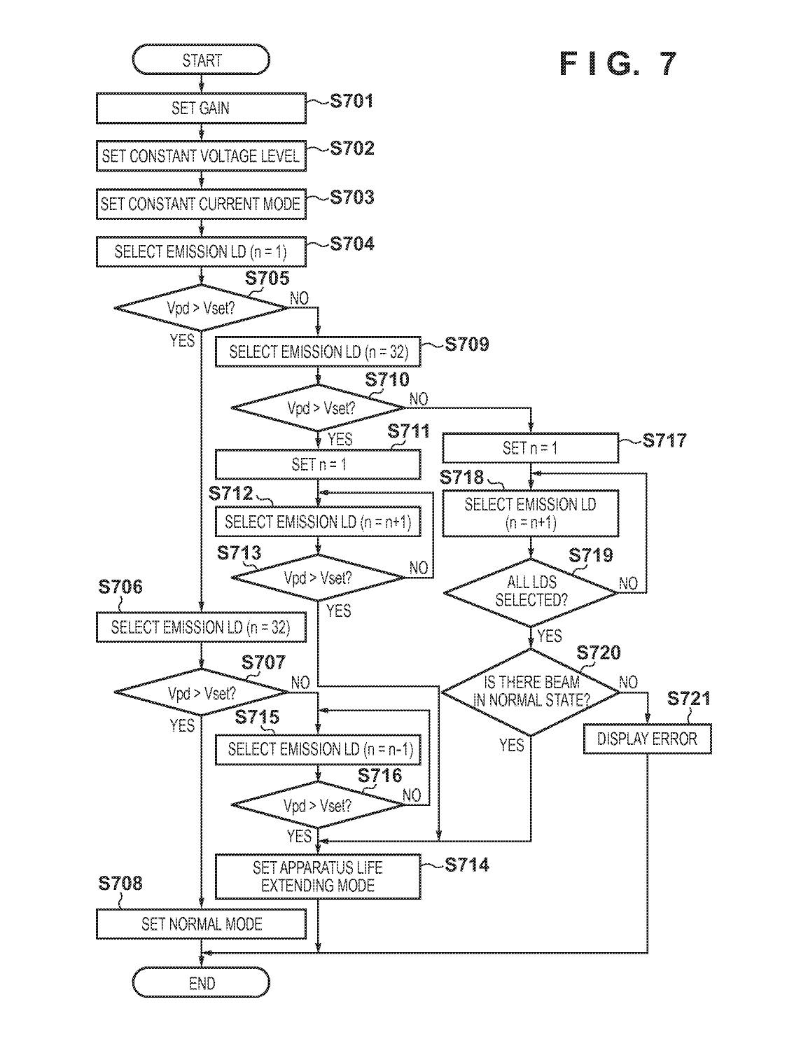

The procedures of inspection processing of the LD 200 to be executed by the CPU 301, which has been described with reference to FIGS. 6A, 6B, and 6C, will be explained with reference to the flowchart shown in FIG. 7. Note that processes in the respective steps of this flowchart are implemented on the laser scanner 101 (image forming apparatus 100) by the CPU 301 reading out and executing a program stored in a ROM (not shown). The following inspection processing can be executed at an arbitrary timing. For example, inspection processing may be executed at the activation timing of the laser scanner 101 (image forming apparatus 100), or the timing when a temperature detected by a temperature detection element such as a thermistor, which is arranged in the image forming apparatus 100 to detect the temperature of the laser scanner 101, exceeds a predetermined temperature. For example, FIG. 7 shows a case in which inspection processing is performed at the activation timing of the image forming apparatus 100.

When the main body of the image forming apparatus 100 is turned on, the CPU 301 sets, in the gain setting unit 306, a gain setting value which has been determined based on measurement in factory shipment (step S701). The CPU 301 also sets a predetermined constant voltage setting value in the constant voltage generation circuit 313 (step S702). Further, the CPU 301 sets the laser control unit 210 in the constant current mode by transmitting control signals (MODE_SEL0=“H” and MODE_SEL1=“L”) to the switch 314 (step S703).

Then, as described above, the CPU 301 performs light emission control for inspection processing from either of LD1 and LD32 arranged at two ends, out of LD1 to LD32 arranged linearly. Here, a case in which light emission control is performed from the LD1 side will be explained.

First, the CPU 301 causes LD1 to output a laser beam by causing LD1 to emit light by a constant current (step S704). The CPU 301 determines whether or not Vpd_D>Vset is satisfied (step S705). If Vpd_D>Vset, the CPU 301 determines that the laser beam output from LD1 has normally entered the light-receiving surface 400 of the PD 213 (normal state). In this case (“YES” in step S705), the CPU 301 next causes LD32 to output a laser beam by causing LD32 to emit light by a constant current (step S706). The CPU 301 determines whether or not Vpd_D>Vset is satisfied (step S707). If Vpd_D>Vset, the CPU 301 determines that the laser beam output from LD32 has normally entered the light-receiving surface 400 of the PD 213 (normal state). In this manner, if the incident states of laser beams from both LD1 and LD32 on the light-receiving surface 400 are the normal state, it can be determined that the incident states of laser beams output from the remaining LDs are also the normal state. Thus, the CPU 301 sets, as an operation mode when executing a print job in the image forming apparatus 100, a normal mode in which all LD1 to LD32 are used. When executing a print job in the image forming apparatus 100, the CPU 301 causes the photosensitive drum 102 to be exposed by using all LD1 to LD32.

Next, a case in which the incident state of a laser beam corresponding to LD1 on the light-receiving surface 400 is the abnormal state (“NO” in step S705) will be explained. In this case, the CPU 301 next causes LD32 to output a laser beam by causing LD32 to emit light by a constant current (step S709). The CPU 301 further determines whether or not Vpd_D>Vset is satisfied (step S710). If Vpd_D>Vset, the CPU 301 determines that the laser beam output from LD32 has normally entered the light-receiving surface 400 of the PD 213 (normal state). This state corresponds to a state in which the incident points of laser beams on the LD1 side deviate from the light-receiving surface 400 of the PD 213, as shown in FIG. 6A. Thus, the CPU 301 next selects LD2 adjacent to LD1 as a control target (sets n=2) (step S711), and causes LD2 to output a laser beam by causing LD2 to emit light by a constant current (step S712). If the CPU 301 determines that even LD2 is in the abnormal state, it causes adjacent LDs in order of LD3, LD4, LD5, . . . to emit light by a constant current, and continues light emission control and determination processing until it is determined that the incident state of a laser beam is the normal state (steps S712 and S713). If the CPU 301 specifies an LD in the normal state (“YES” in step S713), it advances the process to step S714.

Next, a case in which the incident state of a laser beam corresponding to LD1 on the light-receiving surface 400 is the normal state and the incident state of a laser beam corresponding to LD32 on the light-receiving surface 400 is the abnormal state (“NO” in step S707) will be explained. This case corresponds to a state in which the incident points of laser beams on the LD32 side deviate from the light-receiving surface 400 of the PD 213, as shown in FIG. 6B. Thus, the CPU 301 next selects LD31 adjacent to LD32 as a control target, and causes LD31 to output a laser beam by causing LD31 to emit light by a constant current (step S715). If the CPU 301 determines that even LD31 is in the abnormal state, it causes adjacent LDs in order of LD30, LD29, LD28, . . . to emit light by a constant current, and continues light emission control and determination processing until it is determined that the incident state of a laser beam is the normal state (steps S715 and S716). If the CPU 301 specifies an LD in the normal state (“YES” in step S716), it advances the process to step S714.

Next, a case in which the incident states of both laser beams corresponding to LD1 and LD32 on the light-receiving surface 400 are the abnormal state (“NO” in step S710) will be explained. This case corresponds to the state shown in FIG. 6C. The CPU 301 determines that the incident points of many laser beams deviate from the light-receiving surface 400 of the PD 213, sets all LDs as control targets, and continues inspection processing. First, the CPU 301 selects LD2 as a control target (sets n=2) (step S717), causes LD2 to output a laser beam by causing LD2 to emit light by a constant current, and determines the incident state of the laser beam on the light-receiving surface 400 (step S718). Further, the CPU 301 selects LD3 to LD31 as control targets in order, causes them to output laser beams by causing them to emit light, and determines the incident states of the laser beams on the light-receiving surface 400 (steps S718 and S719). If light emission control and inspection processing are completed for all LDs (“YES” in step S719), the CPU 301 determines whether or not there is an LD for which the incident state is the normal state (step S720). If there is an LD for which the incident state is the normal state, the CPU 301 advances the process to step S714, and otherwise it advances the process to step S721.

In step S721, since there is no LD for which the incident state is the normal state, the CPU 301 sends a notification indicative of this to the main body of the image forming apparatus 100, and causes the main body of the image forming apparatus 100 to display an error. The user is then notified of the error representing that no LD is available and the laser scanner 101 cannot be used. If the process advances to step S714, the CPU 301 sets, as an operation mode when executing a print job in the image forming apparatus 100, an apparatus life extending mode in which only LDs in a normal incident state are used. When executing a print job in the image forming apparatus 100, the CPU 301 uses only LDs in the normal state for APC and exposure in the laser scanner 101. More specifically, the CPU 301 excludes, from APC targets, an LD for which it is determined that the incident state of a laser beam on the light-receiving surface 400 of the PD 213 is the abnormal state, out of LD1 to LD32, until a serviceman repairs or replaces the laser scanner 101. The CPU 301 performs exposure control on the photosensitive drum 102 by using LDs determined to be in the normal state without using LDs determined to be in the abnormal state.

Note that the CPU 301 may notify the user (serviceman) of the determination result of the incident state of a laser beam on the light-receiving surface 400 of the PD 213 for each of LD1 to LD32 that has been obtained by the above-described inspection processing. Such notification can be made by, for example, displaying information representing the determination result on the display unit of the image forming apparatus 100.

<Apparatus Life Extending Mode>

Finally, the apparatus life extending mode in the image forming apparatus 100 will be explained. The apparatus life extending mode is an operation mode in which image formation is performed using only LDs for which the incident state of a laser beam on the light-receiving surface 400 of the PD 213 is the normal state, thereby enabling image formation until the serviceman repairs or replaces the laser scanner 101.

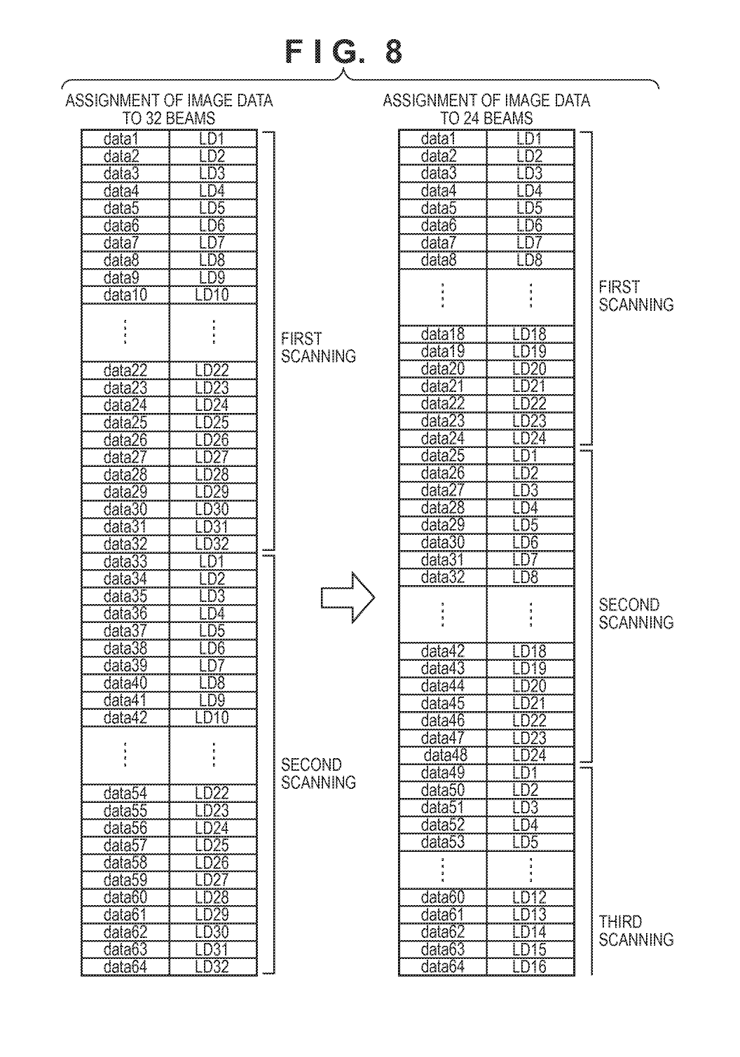

For example, a case in which eight beams corresponding to LD25 to LD32 deviate from the light-receiving surface 400 of the PD 213 will be explained. When eight beams out of 32 beams are abnormal, the number of usable beams becomes ¾ of the number of originally usable beams. Accordingly, the controller 250 (CPU 301) converts image data used in image formation (exposure) so that data assigned to 32 beams so far are assigned to 24 beams, as shown in FIG. 8. In addition, the controller 250 (CPU 301) raises, by the decrease in the number of beams, the rotational speed of the polygon motor 205 (that is, the scanning speed of a laser beam on the surface of the photosensitive drum 102) and the image clock. As a result, the laser scanner 101 is enabled to remain usable, and image formation (exposure) is enabled to be temporarily performed, as in a case in which the incident states of all laser beams are the normal state (the operation mode is the normal mode). In the embodiment, the polygon motor 205 is an example of a scanning unit.

For example, when the rotational speed of the polygon motor 205 cannot be changed, image data may be converted so that data assigned to 32 beams are assigned to 24 beams, and the output speed of the image data from the main body of the image forming apparatus 100 may be decreased to ¾.

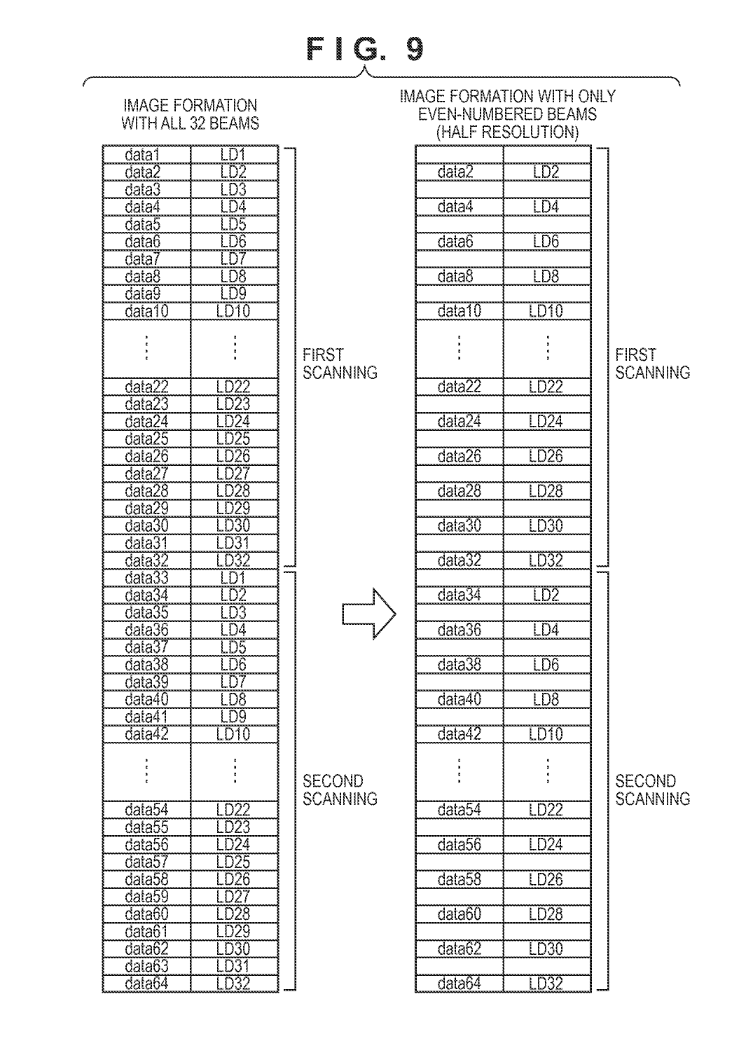

It is also possible to use only even-numbered beams when, for example, the incident state of a laser beam corresponding to LD1 is the abnormal state, and use only odd-numbered beams when the incident state of a laser beam corresponding to LD32 is the abnormal state, as shown in FIG. 9. That is, by decreasing (halving) the image resolution for image formation (exposure), image formation (exposure) can be performed until the laser scanner 101 is repaired or replaced.

Note that control of the number of beams, the resolution, the rotational speed of the polygon motor 205, and the image output speed in the apparatus life extending mode is not limited to the above-described control, and can be performed properly in accordance with the number of laser beams in an abnormal incident state.

As described above, according to the first embodiment, the incident states of laser beams output from a plurality of LDs on the light-receiving surface 400 of the PD for detecting the laser beams in the laser scanner 101 can be determined appropriately. In a case where the plurality of LDs (LD1 to LD32) are arranged linearly, the incident states of laser beams output from a plurality of LDs on the light-receiving surface 400 of the PD 213 for detecting the light powers of the laser beams can be determined appropriately in a shorter time.

When the incident state of a laser beam on the light-receiving surface 400 of the PD 213 is abnormal, the use of the LD can be stopped to prevent a failure of the LD before it happens. The laser scanner 101 (image forming apparatus 100) can be kept used to continue exposure and image formation by using LDs in the normal state until the serviceman takes a proper measure, for example, repairs or replaces the laser scanner 101. By the above-mentioned inspection processing, it is determined whether or not a laser beam has entered the light-receiving surface 400 of the PD 213. This can obviate the need to unnecessarily increase the area of the light-receiving surface 400 of the PD 213 and shorten the time taken for APC.

### Second Embodiment

The second embodiment will describe inspection processing of an LD 200 in a case where a plurality of LDs (LD1 to LD32) are arranged side by side two-dimensionally (in a planar shape) in the LD 200. For descriptive convenience, a description of a part common to that in the first embodiment will not be repeated.

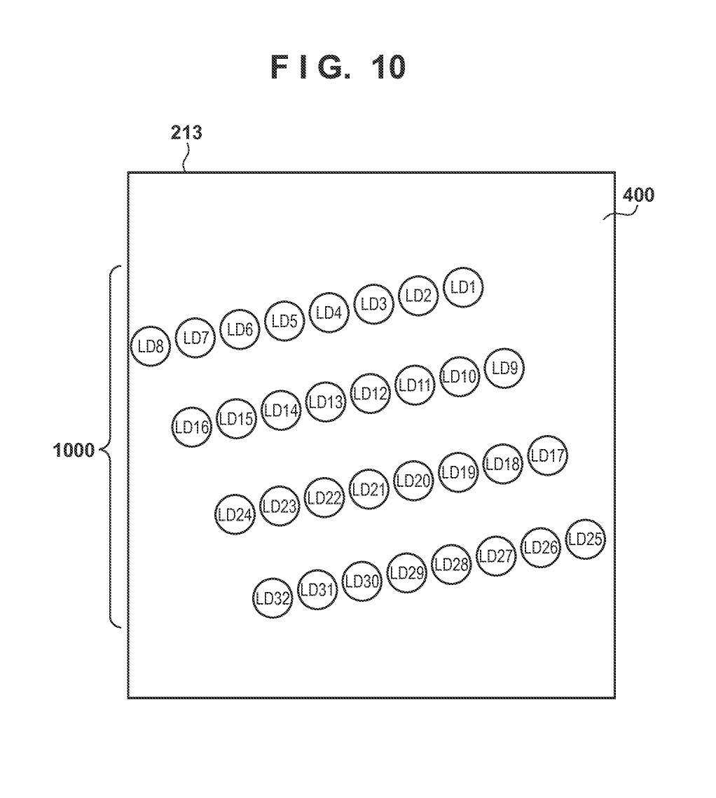

FIG. 10 shows incident points 1000 of laser beams output from respective LDs on a light-receiving surface 400 of a PD 213 in a case where the plurality of LDs (LD1 to LD32) are arranged side by side two-dimensionally (in a planar shape) in the LD 200. Since LD1 to LD32 are arranged side by side in a planar shape as shown in FIG. 10, the incident points 1000 of laser beams are also positioned in a planar shape on the light-receiving surface 400 of the PD 213.

Also in the second embodiment, a CPU 301 performs inspection processing in a shorter time by limiting, as much as possible, target LDs in light emission control for inspection processing. More specifically, the CPU 301 selects, as control targets, inner adjacent LDs in order from an LD arranged outside, out of LD1 to LD32, and causes them to emit light. In addition, the CPU 301 determines, in the selection order, the incident state of a laser beam output from each LD on the light-receiving surface 400, as in the first embodiment.

In the example shown in FIG. 10, when the incident states of some LDs, out of LD1 to LD32, become an abnormal state, the incident points of output laser beams deviate from the light-receiving surface 400 in order from an LD close to an LD (LD1, LD32, LD8, or LD25) at one of ends in the vertical or horizontal direction (the incident states become the abnormal state). When all laser beams output from LDs (LD1, LD32, LD8, and LD25) at these ends deviate from the light-receiving surface 400 (the incident states become the abnormal state), it can be determined that the incident states of all the remaining LDs are also the abnormal state. Thus, the CPU 301 first sets, as emission targets, LD1, LD32, LD8, and LD25 positioned at the ends (outside), out of LD1 to LD32 arranged in a planar shape. If the CPU 301 determines that the incident state of one of these LDs is the abnormal state, it performs inspection processing while setting inner adjacent LDs as light emission control targets in order from the LD determined to be in the abnormal state.

According to the second embodiment, even in a case where a plurality of LDs (LD1 to LD32) are arranged side by side in a planar shape, the incident states of laser beams output from the plurality of LDs on the light-receiving surface of the PD 213 for detecting the light powers of the laser beams can be determined appropriately in a shorter time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-125008, filed Jun. 13, 2013, which is hereby incorporated by reference herein in its entirety.

What is claimed is:

1. An exposure apparatus which exposes a surface of a photosensitive member with a plurality of laser beams, comprising:
a plurality of laser light sources each configured to output a laser beam of a light power corresponding to a supplied current;
a beam splitter configured to split each of the plurality of laser beams emitted by the plurality of laser light sources;
an optical member configured to guide one laser beam split by the beam splitter to the photosensitive member for each of the plurality of laser beams;
a light-receiving unit configured to receive another laser beam split by the beam splitter for each of the plurality of laser beams;
a light power detection unit configured to detect a light power of the laser beam entering the light-receiving unit;
an light emission control unit configured to control, as a control target, at least one laser light source among the plurality of laser light sources, the emission control unit supplying a current of a predetermined value to cause the laser light source serving as the control target to emit light and output a laser beam; and
a determination unit configured to determine an incident state of the laser beam on the light-receiving unit, based on a result of comparison between the predetermined current value and a light power detection value from the light power detection unit for the laser beam output from the laser light source serving as the control target by the emission control unit.

2. The apparatus according to claim 1, wherein
the determination unit determines the incident state by comparing the light power detection value from the light power detection unit with a reference value corresponding to the predetermined value,
in a case where the light power detection value from the light power detection unit exceeds the reference value, the determination unit determines that the incident state is a normal state in which the laser beam has entered the light-receiving unit, and
in a case where the light power detection value from the light power detection unit does not exceed the reference value, the determination unit determines that the incident state is an abnormal state in which the laser beam has not entered the light-receiving unit.

3. The apparatus according to claim 2, wherein
the plurality of laser light sources are arranged side by side linearly,
the plurality of laser beams output from the plurality of laser light sources enter a plurality of incident points arranged side by side linearly in the light-receiving unit,
the emission control unit selects adjacent laser light sources as control targets in order from a laser light source arranged at an end, out of the plurality of laser light sources, and causes each selected laser light source to emit light, and
the determination unit determines the incident state of a laser beam output from each laser light source in order of selection by the emission control unit.

4. The apparatus according to claim 3, wherein
the emission control unit first selects laser light sources arranged at two ends as the control targets, out of the plurality of laser light sources, and causes each selected laser light source to emit light, and
in a case where the determination unit determines that one of laser beams output from the laser light sources arranged at the two ends is in the abnormal state, the emission control unit selects adjacent laser light sources as the control targets in order from a laser light source corresponding to the laser beam determined to be in the abnormal state, and causes each selected laser light source to emit light.

5. The apparatus according to claim 4, wherein
in a case where the determination unit determines that a laser beam output from one of the plurality of laser light sources is in the normal state while causing the plurality of laser light sources to emit light in order, the emission control unit ends control of the plurality of laser light sources, and
the determination unit determines that the incident state of each of laser beams output from remaining laser light sources not selected as the control targets by the emission control unit is the normal state.

6. The apparatus according to claim 3, wherein
the emission control unit first selects laser light sources arranged at two ends as the control targets, out of the plurality of laser light sources, and causes each selected laser light source to emit light, and
in a case where the determination unit determines that both laser beams output from the laser light sources arranged at the two ends are in the abnormal state, the emission control unit selects all the plurality of laser light sources as the control targets in order, and causes each selected laser light source to emit light.

7. The apparatus according to claim 2, wherein
the plurality of laser light sources are arranged side by side in a planar shape,
the plurality of laser beams output from the plurality of laser light sources enter a plurality of incident points arranged side by side in the planar shape in the light-receiving unit,
the emission control unit selects inner adjacent laser light sources as control targets in order from a laser light source arranged outside, out of the plurality of laser light sources, and causes each selected laser light source to emit light, and
the determination unit determines the incident state of a laser beam output from each laser light source in order of selection by the emission control unit.

8. The apparatus according to claim 2, further comprising a light power control unit configured to control a light power of a laser beam output from each of the plurality of laser light sources by controlling a current supplied to each laser light source so as to make the light power detection value from the light power detection unit equal to a target value,
wherein the light power control unit excludes, from control targets of light powers of the laser beams, a laser light source for which the determination unit determines the incident state to be the abnormal state, out of the plurality of laser light sources.

9. The apparatus according to claim 2, further comprising an exposure control unit configured to control exposure by a plurality of laser beams output from the plurality of laser light sources,
wherein the exposure control unit controls to perform the exposure by using a laser light source for which the determination unit determines the incident state to be the normal state, out of the plurality of laser light sources, without using a laser light source for which the determination unit determines the incident state to be the abnormal state.

10. The apparatus according to claim 9, wherein
the optical member includes a scanning unit configured to scan, on the surface of the photosensitive member, a plurality of laser beams output from the plurality of laser light sources, and
the exposure control unit controls a speed of scanning by the scanning unit in accordance with a number of laser light sources for which the determination unit determines the incident state to be the abnormal state.

11. The apparatus according to claim 9, wherein the exposure control unit controls to decrease an image resolution for the exposure in accordance with a number of laser light sources for which the determination unit determines the incident state to be the abnormal state.

12. The apparatus according to claim 1, wherein control of the plurality of laser light sources by the emission control unit, and determination of the incident state by the determination unit are executed at an activation timing of the exposure apparatus.

13. The apparatus according to claim 1, further comprising a temperature detection unit configured to detect a temperature of the exposure apparatus,
wherein control of the plurality of laser light sources by the emission control unit, and determination of the incident state by the determination unit are executed at a timing when the temperature detected by the temperature detection unit exceeds a predetermined temperature.

14. The apparatus according to claim 1, further comprising a notification unit configured to notify a user of a result of determination of the incident state by the determination unit for each of the plurality of laser light sources.

15. An image forming apparatus including a photosensitive member, comprising:
a charging unit configured to charge a surface of the photosensitive member;
an exposure apparatus configured to expose the surface of the photosensitive member with a plurality of laser beams output from a plurality of laser light sources; and
a developing unit configured to develop an electrostatic latent image formed on the surface of the photosensitive member by exposure by the exposure apparatus, and form, on the surface of the photosensitive member, an image to be transferred to a printing medium,
wherein the exposure apparatus includes:
the plurality of laser light sources each configured to output a laser beam of a light power corresponding to a supplied current;
a beam splitter configured to split each of the plurality of laser beams emitted by the plurality of laser light sources;
an optical member configured to guide one laser beam split by the beam splitter to the photosensitive member for each of the plurality of laser beams;
a light-receiving unit configured to receive another laser beam split by the beam splitter for each of the plurality of laser beams;
a light power detection unit configured to detect a light power of the laser beam entering the light-receiving unit;
an emission control unit configured to control, as a control target, at least one laser light source among the plurality of laser light sources, the emission control unit supplying a current of a predetermined value to cause the laser light source serving as the control target to emit light and output a laser beam; and
a determination unit configured to determine an incident state of the laser beam on the light-receiving unit, based on a result of comparison between the predetermined current value and a light power detection value from the light power detection unit for the laser beam output from the laser light source serving as the control target by the emission control unit.
